(19) United States
(12) Patent Application Publication
(10) Pub. No.: US 2008/0067991 A1
(43) Pub. Date: Mar. 20, 2008

(54) CURRENT GENERATING APPARATUS AND FEEDBACK-CONTROLLED SYSTEM UTILIZING THE CURRENT GENERATING APPARATUS

(76) Inventors: Chien-Lung Lee, Hsinchu City (TW); Yi-Wen Huang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/567,228

(22) Filed: Dec. 6, 2006

Related U.S. Application Data
(60) Provisional application No. 60/826,076, filed on Sep. 18, 2006.

(51) Int. Cl. G05F 1/00

(52) U.S. Cl. 323/273

(57) ABSTRACT

The present invention discloses a current generating apparatus for generating an output current. The current generating apparatus includes: a first current mirror; a first bias current generator for providing a first bias current, and the first bias current generator includes: a first current source for providing the first current; and a capacitive device for conducting a reference current; a second current mirror for generating a second mirror current; a second bias current generator for generating a second current; a third current source for providing a third current, wherein the second mirror current is equal to the third current; a feedback circuit; and a fourth current source for providing a fourth current, wherein the output current is outputted at an output node of the first current mirror.

### CROSS REFERENCE TO RELATED APPLICATIONS

This application claims the benefit of U.S. Provisional Application No. 60/826,076, which was filed on Sep. 18, 2006 and is included herein by reference.

### BACKGROUND OF THE INVENTION

1. Field of the Invention

The present invention relates to providing frequency compensation, and more particularly, to a feedback-controlled system (e.g., an LDO voltage regulator) using a current generating apparatus capable of minimizing the DC offset of an output current used for frequency compensation.

2. Description of the Prior Art

Please refer to FIG. 1. FIG. 1 is a diagram illustrating a first conventional LDO (low dropout) voltage regulator 10. The LDO voltage regulator 10 comprises a pass transistor MP, a feedback voltage divider 11, and an error amplifier 12. The connections between the pass transistor MP, the feedback voltage divider 11, and the error amplifier 12 are shown in FIG. 1. The input terminal Nᵢₙ of the LDO voltage regulator 10 is coupled to a supply voltage VDD. The output terminal Nₒᵤₜ of the LDO voltage regulator 10 is coupled to a loading stage, which is equivalent to a resistor R_{L} connected with a capacitor C_{L} in parallel. Please note that the terminal N_{g} has a parasitic resistor R_{PAR} and a parasitic capacitor C_{PAR}, where the capacitor C_{L} has an equivalent series resistance of R_{ESR} connected to the capacitor C_{L}. Accordingly, it is well-known that there are two low-frequency poles that need to be taken into account when determining the closed-loop transfer function of the frequency response of the LDO voltage regulator 10. In order to guarantee the phase margin of the LDO voltage regulator 10 will be greater than 45 degrees, a zero is introduced to compensate the phase contribution of the two low-frequency poles. Normally, the series combination of the capacitor C_{L} and the equivalent series resistance R_{ESR} generates a zero ω_{ESR} that provides the LDO voltage regulator 10 with proper phase margin. However, in some conditions, the equivalent series resistance R_{ESR} fails to provide proper phase margin for the LDO voltage regulator 10. Please refer to FIG. 2. FIG. 2 is a frequency response diagram of the LDO voltage regulator 10 with various load currents I_{L} at fixed ω_{ESR}. For brevity, three Bode plots 21, 22, and 23 are shown in FIG. 2, which correspond, respectively, to light load current, proper load current, and heavy load current of the LDO voltage regulator 10. Furthermore, there are three poles and one zero for each of the Bode plots 21, 22, and 23, in which the first pole ωₚ₁ is mainly concentrated at the output terminal Nₒᵤₜ, the second pole ωₚ₂ is mainly concentrated at the terminal N_{g} of the transistor MP, and the zero is ω_{ESR}. When the load current I_{L} varies from the heavy load status to the light load status, the first pole ωₚ₁ decreases roughly and the second pole ωₚ₂ decreases as well, as shown in the Bode plots 21, 22, and 23 of FIG. 2. Furthermore, three of the Bode plots 21, 22, and 23 have poor phase margin in this case. There are at least three drawbacks by utilizing the zero ω_{ESR} to compensate the pole of the LDO voltage regulator 10. Firstly, the high-frequency bypass capacitor C_{gdpass} placed in parallel with the capacitor C_{L} provides another pole with the zero ω_{ESR} of the capacitor C_{L}, in which the new pole will further decrease the phase margin of the LDO voltage regulator 10. Secondly, the equivalent series resistance of R_{ESR} of the capacitor C_{L} is not properly specified in many cases and varies with temperature. As a result, the zero ω_{ESR} cannot be predicted easily. Thirdly, owing to some advantages of ceramic capacitors, such as low R_{ESR}, less expense, and compact printed circuit boards, using the ceramic capacitor is becoming more popular. However, it is hard to generate a proper zero ω_{ESR} with the low R_{ESR}.

Besides utilizing the zero ω_{ESR} to compensate the pole of the LDO voltage regulator 10, there are various other frequency compensation means taught in the prior art. Please refer to FIG. 3. FIG. 3 is a diagram illustrating a second conventional LDO voltage regulator 30 having a prior art frequency compensation implemented therein. The LDO voltage regulator 30 shown in FIG. 3 is equivalent to applying the prior art frequency compensation to the LDO voltage regulator 10. The frequency compensation method of FIG. 3 is to provide a feedback path for the output voltage Vₒᵤₜ through an additional capacitor CF, and the connection is shown in FIG. 3. The capacitor CF provides a high-frequency bypass path for the loop gain of the LDO voltage regulator 10. Then a pole-zero pair (ωₚ, ω_{z}) is generated, which is represented by the following equation (1) and equation (2),

ω_{z}=1/(R_{F1}*CF), (1)

ωₚ=(1+(R_{F1}/R_{F2}))/(R_{F1}*CF) (2)

According to this prior art circuit configuration, due to the fact that the resistance magnitudes of feedback resistors R_{F1} and R_{F2} have the same order, the pole ωₚ and the zero ω_{z} are not far from each other as shown in FIG. 4. FIG. 4 is a diagram illustrating the frequency response of capacitive feedback frequency compensation of FIG. 3. The curve 41 represents the transferring characteristic of the frequency compensation of FIG. 3, and the curve 42 represents the phase variation of the frequency compensation of FIG. 3. Accordingly, the zero ω_{z} contributes less phase margin for the frequency compensation of FIG. 3.

According to the reference of Chaitanya K. Chaya, and Jose Silva-Martinez, “A Frequency Compensation Scheme for LDO Voltage Regulators”, IEEE TRANSACTIONS ON CIRCUITS AND SYSTEMS-I. REGULAR PAPERS, VOL. 51, NO. 6, JUN. 2004, an improved prior art frequency compensation developed from the frequency compensation of FIG. 3 is proposed. Please refer to FIG. 5. FIG. 5 is a diagram illustrating a third conventional LDO voltage regulator 50 having another prior art frequency compensation implemented therein. The LDO voltage regulator 50 shown in FIG. 5 is equivalent to applying the improved prior art frequency compensation to the LDO voltage regulator 10. The frequency compensation of FIG. 5 is implemented using a frequency-dependent voltage-controlled current source (VCCS) 52 connected at the feedback terminal N_{FB} of the LDO voltage regulator 50. The frequency-dependent VCCS 52 is capable of eliminating the pole ωₚ of FIG. 3 and generate a new zero ω_{z0}. The new zero ω_{z0} is determined by the following equation:

ω_{z0}=1/(N*R_{F1}*CF). (3)

Therefore, the location of the new zero ω_{z0} can be easily adjusted by modifying the current mirror ratio N set to the current mirrors 54a, 54b or modifying the capacitance of the ground capacitor C₁ of the FIG. 6. FIG. 6 is a diagram illustrating the frequency-dependent voltage-controlled current source 52 shown in FIG. 5. However, the mismatch of the current mirror 54a and the current mirror 54b, both having the same current mirror ratio N, induces a DC current ΔI_{B} flowing into the feedback resistors R_{F1}, R_{F2}, and equivalently forms a mismatch resistor R_{mismatch} parallel with the feedback resistors R_{F1}, R_{F2} as shown in FIG. 6. Hence, the output voltage Vₒᵤₜ varies due to the mismatch resistor R_{mismatch} from the imbalanced current mirrors 54a, 54b. Furthermore, the mismatch of current mirrors 54a, 54b contributes considerable yield loss for chip mass production. In addition, the mismatch current ΔI_{B} is in proportion to the current mirror ratio N of current mirrors 54a, 54b. Furthermore, as the output voltage Vₒᵤₜ changes, the mismatch current ΔI_{B} changes accordingly. In order to decrease the effect of the mismatch current ΔI_{B}, the current mirror ratio N of the current mirrors 54a, 54b should preferably be lower, and the capacitance of the grounded capacitor C₁ should preferably be larger. However, the larger the capacitance, the higher the production cost and chip area becomes.

### SUMMARY OF THE INVENTION

Therefore, one of the objectives of the present invention is to provide a feedback-controlled system (e.g. an LDO voltage regulator) using a current generating apparatus capable of minimizing the DC offset of an output current used for frequency compensation.

According to an embodiment of the present invention, a current generating apparatus is disclosed for generating an output current. The current generating apparatus comprises: a first current mirror, a first bias current generator, a second current mirror, a second bias current generator, a third current source, a feedback circuit, and a fourth current source. The first current mirror generates a first mirror current according to a first bias current and a current mirror ratio. The first bias current generator is coupled to the first current mirror for providing the first bias current according to a first current and a reference current, and the first bias current generator comprises: a first current source biased by a first bias voltage for providing the first current; and a capacitive device coupled to the first current source in parallel for conducting the reference current. The second current mirror generates a second mirror current according to a second bias current and the current mirror ratio. The second bias current generator is coupled to the second current mirror, and the second bias current generator has a second current source biased by the first bias voltage for generating a second current serving as the second bias current. The third current source is coupled to an output node of the second current mirror, and is biased by a second bias voltage to provide a third current, wherein the second mirror current is equal to the third current. The feedback circuit is coupled to the output node of the second current mirror and the third current source for tuning the second bias voltage according to a voltage level at the output node of the second current mirror and a target voltage level. The fourth current source is coupled to an output node of the first current mirror, and is biased by the second bias voltage to provide a fourth current, wherein the output current is outputted at the output node of the first current mirror.

According to an embodiment of the present invention, a feedback-controlled system is disclosed. The feedback-controlled system comprises: a plurality of operational stages cascaded in a closed loop; and a current generating apparatus. The current generating apparatus generates an output current to an output of a first operational stage in the operational stages. The current generating apparatus comprises: a first current mirror, a first bias current generator, a second current mirror, a second bias current generator, a third current source, a feedback circuit, and a fourth current source. The first current mirror generates a first mirror current according to a first bias current and a current mirror ratio. The first bias current generator is coupled to the first current mirror for receiving an output of a second operational stage in the operational stages and providing the first bias current according to a first current and a reference current. The first bias current generator comprises: a first current source for providing the first current according to a first bias voltage and the output of the second operational stage; and a capacitive device coupled to the first current source in parallel for conducting the reference current. The second current mirror generates a second mirror current according to a second bias current and the current mirror ratio. The second bias current generator is coupled to the second current mirror, and the second bias current generator has a second current source for generating a second current serving as the second bias current according to the first bias voltage and the output of the second operational stage. The third current source is coupled to an output node of the second current mirror, and is biased by a second bias voltage to provide a third current, wherein the second mirror current is equal to the third mirror current. The feedback circuit is coupled to the output node of the second current mirror and the third current source for tuning the second bias voltage according to a voltage level at the output node of the second current mirror and a target voltage level. The fourth current source is coupled to an output node of the first current mirror, and is biased by the second bias voltage to provide a fourth current, wherein the output current is outputted from the output node of the first current mirror.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art LDO voltage regulator.

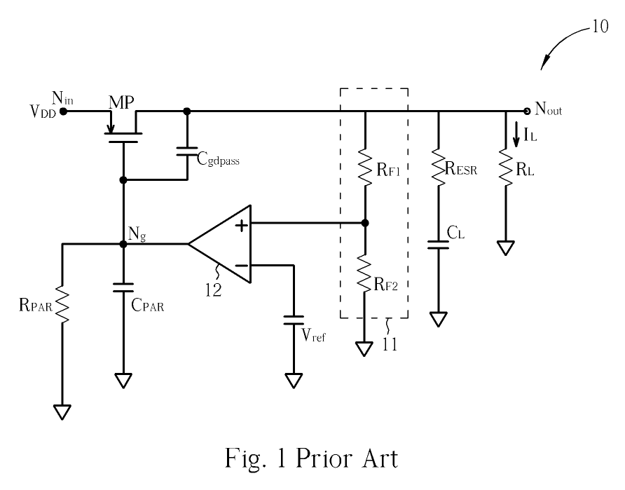

FIG. 2 is a frequency response diagram of the LDO voltage regulator.

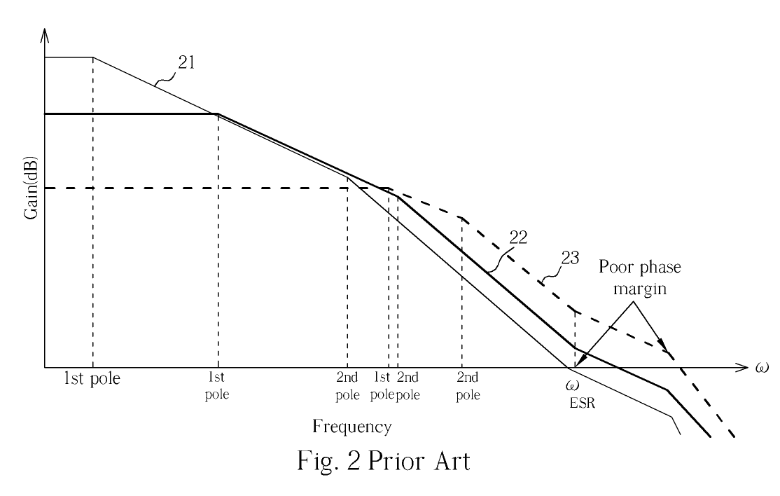

FIG. 3 is a diagram illustrating a frequency compensation according to the prior art utilized in the LDO voltage regulator of FIG. 1.

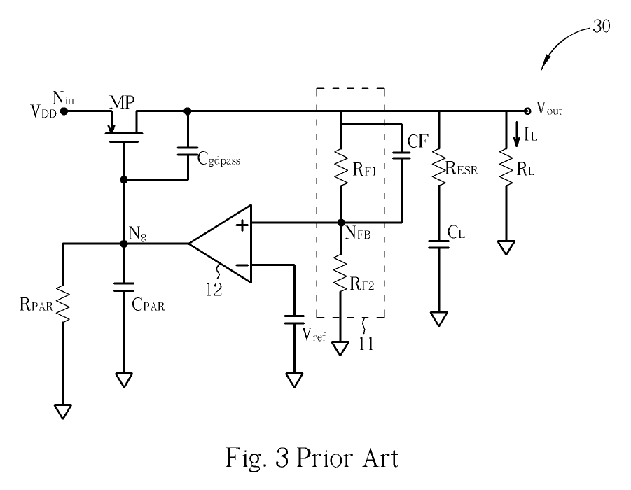

FIG. 4 is a diagram illustrating the frequency response of the capacitive feedback frequency compensation of FIG. 3.

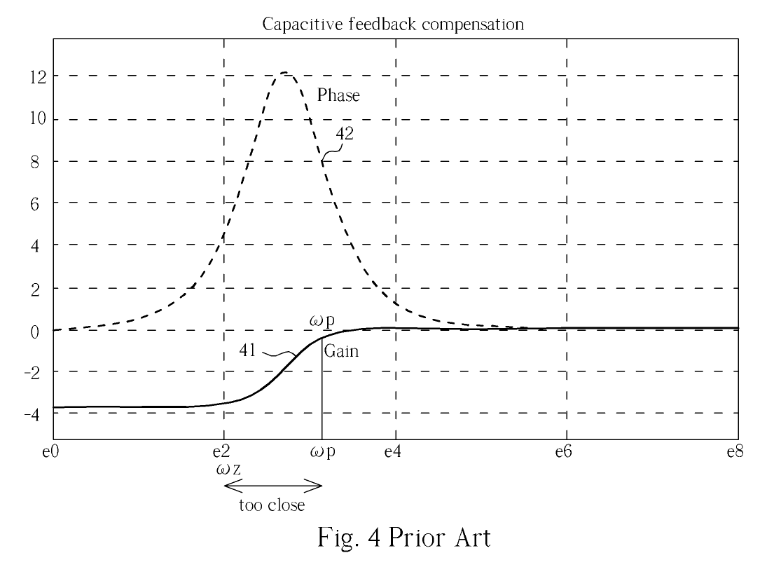

FIG. 5 is a diagram illustrating the prior art frequency compensation that improves on the frequency compensation of FIG. 3.

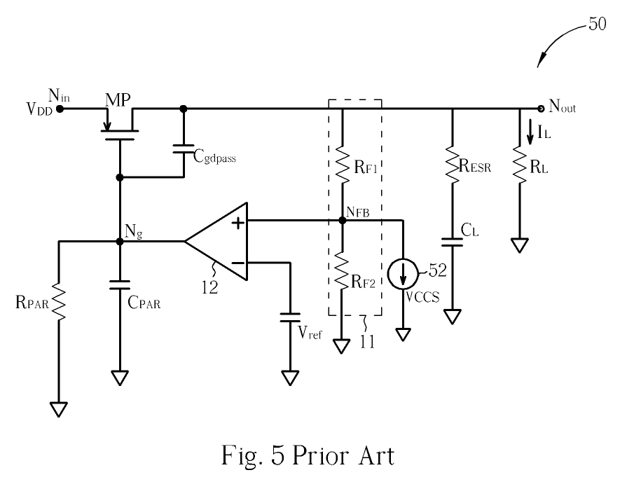

FIG. 6 is a diagram illustrating the prior art frequency-dependent voltage-controlled current source of FIG. 5.

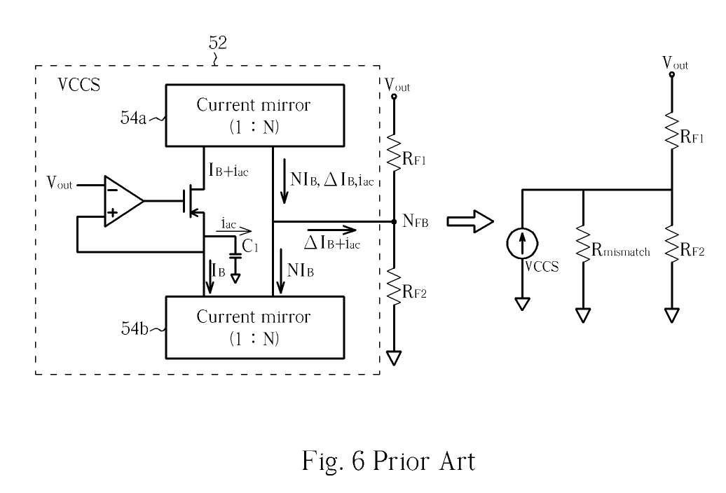

FIG. 7 is a diagram illustrating a voltage regulator according to an embodiment of the present invention.

FIG. 8 is a diagram illustrating the voltage-controlled current source in the voltage regulator of FIG. 7.

FIG. 9 is a diagram illustrating an equivalent schematic of the voltage-controlled current source in the voltage regulator of FIG. 7.

FIG. 10 is a diagram illustrating the frequency response of the voltage regulator of FIG. 7.

FIG. 11 is a diagram of a feedback-controlled system according to a second embodiment of the present invention.

### DETAILED DESCRIPTION

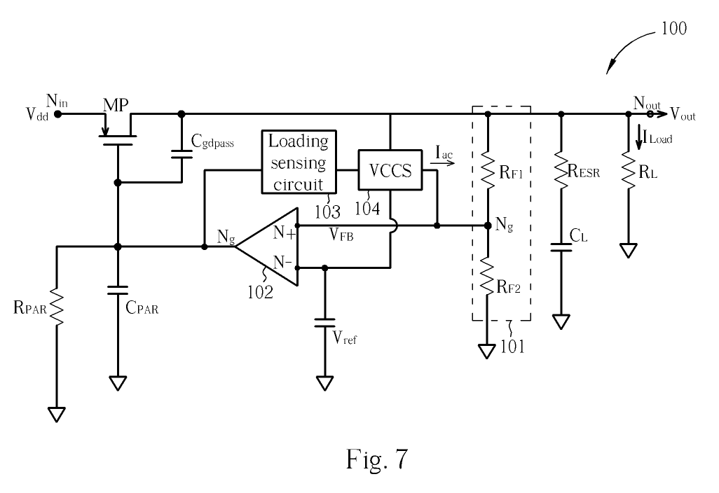

Please refer to FIG. 7. FIG. 7 is a diagram illustrating a voltage regulator 100 according to an embodiment of the present invention. The voltage regulator 100 is a low dropout (LDO) voltage regulator that can track the loading current of the voltage regulator 100 to adjust the zero of the voltage regulator 100. The voltage regulator 100 comprises a pass transistor Mₚ, a voltage divider 101, an error amplifier 102, a loading sensing circuit 103, and a voltage-controlled current source (VCCS) 104. The pass transistor Mₚ, which is a PMOS transistor, has a source terminal Nᵢₙ coupled to a supply voltage V_{dd} and a drain terminal Nₒᵤₜ for outputting an output voltage Vₒᵤₜ. The voltage divider 101 comprises two feedback resistors R_{F1} and R_{F2}, connected in series, where the feedback resistor R_{F1} has a terminal coupled to the drain terminal Nₒᵤₜ and another terminal coupled to the feedback resistor R_{F2}. The voltage divider 101 is utilized for providing a feedback voltage level V_{FB} according to the output voltage Vₒᵤₜ passed by the pass transistor Mₚ. The error amplifier 102 has a first input node (i.e. a non-inverting node) N+ coupled to the voltage divider 101 for receiving the feedback voltage level V_{FB}, a second input node (i.e. an inverting node) N− coupled to the target voltage level V_{ref}, and an output node N_{g} coupled to a gate terminal of the pass transistor Mₚ. The voltage-controlled current source 104 is coupled to the voltage divider 101 (i.e. the first input node N+) for generating an output current I_{ac} at the first input node N+ of the error amplifier 102, in which the output current I_{ac} is a voltage-controlled AC current. The loading sensing circuit 103 is coupled to the voltage-controlled current source 104 and the gate terminal N_{g} (i.e. the output node) of the pass transistor M_{P}, for sensing the loading current I_{Load} variation of the voltage regulator 100 to adjust the output current I_{ac} of the voltage-controlled current source 104. Furthermore, the drain terminal Nₒᵤₜ is coupled to a loading circuit, which is equivalent to a loading resistor R_{L} connected with a loading capacitor C_{L} in parallel. Please note that the loading capacitor C_{L} has an equivalent series resistance of R_{ESR} connected with the loading capacitor C_{L}. The output node N_{g} is connected to a parasitic resistor R_{PAR} and a parasitic capacitor C_{PAR} in parallel.

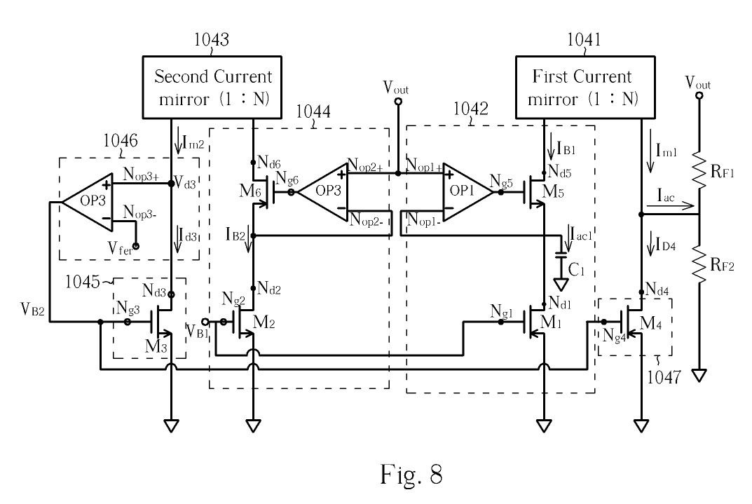

Please refer to FIG. 8. FIG. 8 is a diagram illustrating the voltage-controlled current source 104 in the voltage regulator 100 of FIG. 7. The voltage-controlled current source 104 comprises a first current mirror 1041, a first bias current generator 1042, a second current mirror 1043, a second bias current generator 1044, a third current source 1045, a feedback circuit 1046, and a fourth current source 1047. The first current mirror 1041 generates a first mirror current I_{M1} according to a first bias current I_{B1} and a current mirror ratio N. The first bias current generator 1042 is coupled to the first current mirror 1041 for providing the first bias current I_{B1} according to a first current I_{B} and a reference current I_{ac1}. In this embodiment, the first bias current I_{B1} is a sum of the first current I_{B} and the reference current I_{ac1}. The first bias current generator 1042 comprises a first current source, which is implemented using a transistor M₁, having a gate terminal N_{g1} biased by a first bias voltage V_{B1} for generating the first bias current I_{B1}; and a capacitive device C₁ coupled to the drain terminal N_{d1} of the transistor M₁ in parallel for conducting the reference current I_{ac1}. Therefore, the reference current I_{ac1} is equal to s*C₁*Vₒᵤₜ, where the symbol s represents jω. The second current mirror 1043 generates a second mirror current I_{M2} according to a second bias current I_{B2} and the current mirror ratio N. The second bias current generator 1044 is coupled to the second current mirror 1043 and has a second current source, which is implemented using a transistor M₂ having a gate terminal N_{g2} biased by the first bias voltage V_{B1} for generating a second current I_{B2} serving as the second bias current. In this embodiment, the transistors M₁ and M₂ have the same configuration and are biased by the same bias voltage V_{B1}, thus the first current I_{B1} is equal to the second current I_{B2}. The third current source 1045, which is implemented using a transistor M₃, has a drain terminal N_{d3} coupled to an output node of the second current mirror 1043 and the gate terminal N_{g3} biased by a second bias voltage V_{B2} for providing a third current I_{D3}, wherein the second mirror current 1043 is equal to the third current I_{D3}. The feedback circuit 1046 is coupled to the output node N_{d3} of the second current mirror 1043 and the third current source 1045, for tuning the second bias voltage V_{B2} according to the target voltage level V_{ref} of the voltage regulator 100 and the voltage V_{d3} at the output node N_{d3} of the second current mirror 1043. The fourth current source 1047, which is implemented using a transistor M₄ has a drain terminal coupled to the output node N_{d4} of the first current mirror 1041 and the gate terminal N_{g4} biased by the second bias voltage V_{B2} for providing a fourth current I_{D4}. Furthermore, the output current I_{ac} is outputted at the output node of the first current mirror 1041, which is the first input node N+ of the error amplifier 102.

The first bias current generator 1042 further comprises a transistor M₅ having a drain terminal N_{d5} coupled to the first current mirror 1041, a source terminal coupled to the drain terminal N_{d1} of the transistor M₁ and a gate terminal N_{g5}; and a first error amplifier OP1 having a first input node N_{OP1+} coupled to the output voltage Vₒᵤₜ of the voltage regulator 100, a second input node N_{OP1-} coupled to the source terminal of the transistor M₅, and an output node coupled to the gate terminal N_{g5} of the transistor M₅. In addition, the second bias current generator 1044 further comprises a transistor M₆ having a drain terminal N_{d6} coupled to the second current mirror 1043, a source terminal coupled to a drain terminal N_{d2} of the transistor M₂, and a gate terminal N_{g6}; and a second error amplifier OP2 having a first input node N_{OP2+} coupled to the output voltage Vₒᵤₜ of the voltage regulator 100, a second input node N_{OP2-} coupled to the source terminal of the transistor M₆, and an output node coupled to the gate terminal N_{d6} of the transistor M₆. Please note that, in this embodiment, the circuit configuration of the transistor M₅ and the first error amplifier OP1 is symmetric to that of the transistor M₆ and the second error amplifier OP2. As shown in FIG. 8, the feedback circuit 1046 comprises a third error amplifier OP3 having a first input node N_{OP3+} coupled to the drain terminal N_{d3} of the transistor M₃, a second input node N_{OP3-} coupled to the target voltage level V_{ref}, and an output node coupled to the gate terminal N_{g3} of the transistor M₃. The detailed operation of the voltage-controlled current source 104 is illustrated as below.

Please refer to FIG. 7 in conjunction with FIG. 8. Due to the mirroring imperfection between the first bias current I_{B1} and the first mirror current I_{M1} of the first current mirror 1041, the first current mirror 1041 mirrors the first bias current I_{B1} according to the current mirror ratio N to introduce the mismatch current to the first mirror current I_{M1}, i.e. I_{M1}=N*I_{B1}=N*I_{B}+N*I_{ac1}+ΔI_{B1}, where ΔI_{B1} is the mismatch current induced by the first current mirror 1041. Similarly, due to the mirroring imperfection between the second bias current I_{B2} and the second mirror current I_{M2} of the second current mirror 1043, the second current mirror 1043 mirrors the second bias current I_{B2} according to the current mirror ratio N to introduce the mismatch current to the second mirror current I_{M2}, i.e. I_{M2}=N*I_{B2}+ΔI_{B2}, where ΔI_{B2} is the mismatch current induced by the second current mirror 1043. Please note that, since the second current mirror 1043 is a replica of the first current mirror 1041 in this embodiment (i.e. both have the same current mirror ratio N), the mismatch current ΔI_{B1} is substantially equal to the mismatch current ΔI_{B2}, i.e. ΔI_{B1}=ΔI_{B2}. Additionally, the first error amplifier OP1 is operative to lock the voltage level at the drain terminal N_{d2} to the output voltage Vₒᵤₜ, and the first error amplifier OP1 is also operative to lock the voltage level at the drain terminal N_{d2} to the output voltage Vₒᵤₜ. As shown in FIG. 8, the transistors M₁ and M₂ are both biased by the same bias voltage V_{B1}. As a result, the first current I_{B1} is substantially the same as the second current I_{B2} because of the same bias condition applied to the transistors M₁ and M₂.

On the other hand, the feedback circuit 1046, acting as a common mode feedback circuit of the transistors M₃, is utilized to make the voltage V_{d3} approach to the target voltage level V_{ref} of the voltage regulator 100 by controlling the transistor M₃. Furthermore, the feedback voltage level V_{FB} at the output node N_{d4} also approaches to the target voltage level V_{ref} of the voltage regulator 100 because of the error amplifier 102. Therefore, both of the transistors M₃ and M₄ are operated under substantially identical bias condition. In this way, as the feedback voltage V_{FB} and the drain voltage V_{d3} are both equal to the target voltage V_{ref} with the help of the error amplifier 102 and the third error amplifier OP3, the third current I_{D3} of the transistor M₃ is sure to coincide with the fourth current I_{D4} of the transistor M₄, i.e. I_{D3}=I_{D4}=N*I_{B2}+ΔI_{B2}. Accordingly, referring to Kirchhoff's Laws, the output current I_{ac} can be obtained by subtracting the fourth current I_{D4} from the first mirror current I_{M1} (i.e. I_{M1}=N*I_{B}+N*I_{ac1}+ΔI_{B1}), which is the AC current of N*I_{ac1} (i.e. N*s*C₁*Vₒᵤₜ). Compared with the prior art, the voltage-controlled current source (i.e. the output current I_{ac}) of N*s*C₁*Vₒᵤₜ with no mismatch current ΔI_{B} can be obtained, ideally. In a real application, the induced mismatch current ΔI_{B} is very small, and can be neglected.

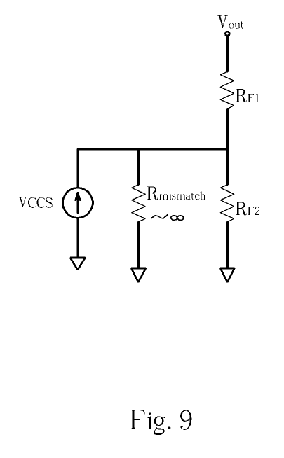

Please refer to FIG. 9. FIG. 9 is a diagram illustrating an equivalent schematic of the voltage-controlled current source 104 in the voltage regulator 100 of FIG. 7. Therefore, as one can see, the voltage-controlled current source 104 provides an ideal frequency-dependent voltage-controlled current source, where R_{mismatch} approaches to ∞.

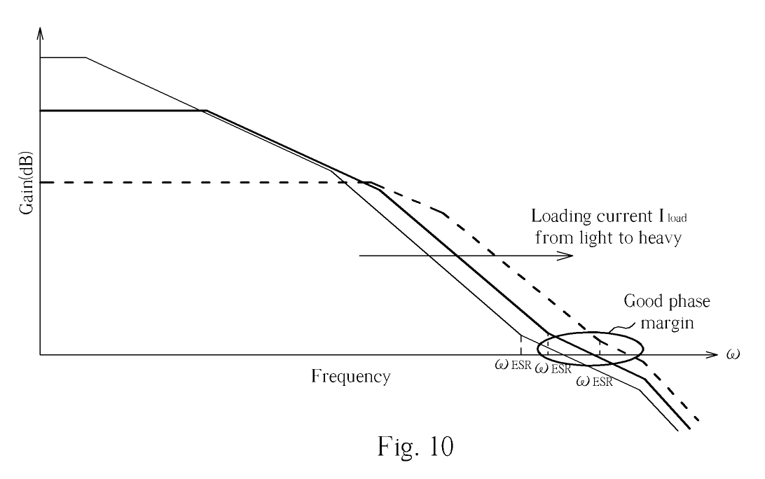

Please refer to FIG. 7 again. In order to obtain a good phase margin for all loading current I_{Load} of the voltage regulator 100 of FIG. 7, a location of zero ω_{ESR} of the voltage regulator 100 should be adjustable with the loading current I_{Load}. In other words, the zero ω_{ESR} is higher for heavy loading current I_{Load} (i.e. small load impedance) and lower for light loading current I_{Load} (i.e. high load impedance) as shown in FIG. 10. FIG. 10 is a diagram illustrating the frequency response of the voltage regulator 100 of FIG. 7. By applying the voltage-controlled current source 104 to compensate the pole of the voltage regulator 100, the zero ω_{ESR} is directly tuned by modifying the current mirror ratio N of the first current mirror 1041 and the second current mirror 1043 according to the loading current I_{Load} monitored by the loading sensing circuit 103. According to the aforementioned equation (3), the zero ω_{ESR} of the voltage regulator 100 can be modified as below:

ω_{ESR}=1/(N*R_{F1}*CF). (4)

In this embodiment, the loading sensing circuit 103 of the present invention is configured to sense the voltage level at the gate terminal N_{g} (i.e. the output node) of the pass transistor M_{P} to detect the loading current variation. Then the loading sensing circuit 103 changes the current mirror ratio N of the first current mirror 1041 and the second current mirror 1043 to modify the zero ω_{ESR} according to the above equation (4). Therefore, as shown in FIG. 10, a good phase margin can be obtained as compared with the prior art. Please note that, the loading sensing circuit 103 of the present invention is not limited to sensing the voltage level at the gate terminal N_{g} of the pass transistor M_{P} to detect the loading current variation. That is, any other terminal voltage of the voltage regulator 100 that can be referred to for tracking the loading current I_{Load} also can be adopted. These alternative designs all fall in the scope of the present invention. In addition, any conventional means of changing the current mirror ratio N of the first current mirror 1041 and the second current mirror 1043 can be utilized in the present invention. Since the technique of tuning the current mirror ratio is well known to those skilled in this art, further description is omitted here for brevity.

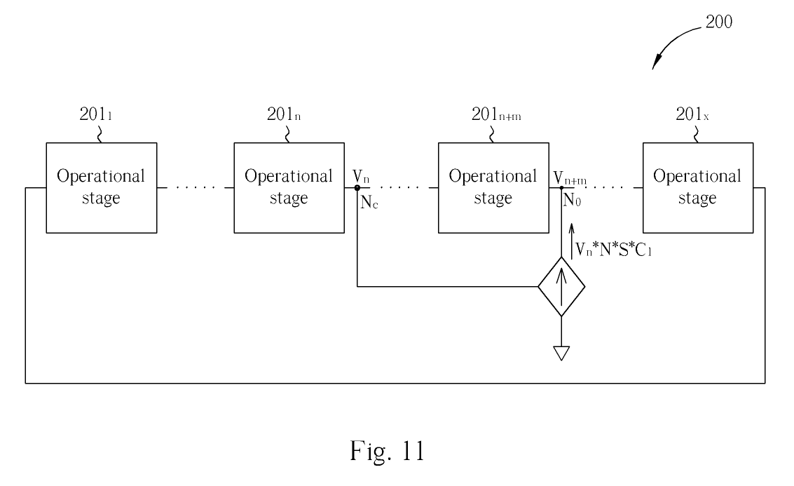

Please refer to FIG. 11. FIG. 11 is a diagram a feedback-controlled system 200 according an embodiment of the present invention. The feedback-controlled system 200 comprises a plurality of operational stages 201₁, . . . , 201ₓ cascaded in a closed loop. In addition, a current generating apparatus 202 is implemented and coupled to the operational stages 201ₙ₊ₘ. Each of the operational stages 201₁, . . . , 201ₓ has a transfer function of A₁, . . . , Aₓ, respectively. The current generating apparatus 202 has a control terminal N_{c} coupled to an output of an n^{th} operational stage 201ₙ and an output terminal Nₒ coupled to an output of a (n+m)^{th} operational stage 201ₙ₊ₘ in the operational stages. The current generating apparatus 202 generates an output current Vn*N*s*C₁ to an output of the (n+m)^{th} operational stage 201ₙ₊ₘ in the operational stages. Please note that, in this embodiment the current generating apparatus 202 is implemented using the above-mentioned voltage-controlled current source 104 shown in FIG. 8, therefore the detailed description is omitted here for brevity. Through the current generating apparatus 202, a zero can be induced to the feedback-controlled system 200. According to FIG. 11, the voltage Vₙ₊ₘ at the output of the (n+m)^{th} operational stage 201ₙ₊ₘ is represented using the following equation (5):

Vₙ₊ₘ=Vₙ*(Aₙ₊₁*Aₙ₊₂ . . . Aₙ₊ₘ)+Vₙ*N*s*C₁*R_{IN}. (5)

Then,

Vₙ₊ₘ/Vₙ=(Aₙ₊₁*Aₙ₊₂ . . . Aₙ₊ₘ+N*s*C₁*R_{IN}). (6)

Thus, a zero ω_{z} can be obtained from the equation (6),

ω_{z}=(Aₙ₊₁*Aₙ₊₂ . . . Aₙ₊ₘ)/(N*C₁*R_{IN}),

wherein C₁ is the capacitive device of the voltage-controlled current source 104 of FIG. 8, R_{IN} is the input resistor at the output of the (n+m)^{th} operational stage 201ₙ₊ₘ, and N is the current mirror ratio of the first current mirror 1041 and the second current mirror 1043. Therefore, by utilizing the current generating apparatus 202 zero ω_{z} can be added to the feedback-controlled system 200 and without introducing any pole.

It should be note that a person skilled in this art can readily appreciate that the voltage regulator is a kind of the feedback-controlled system. Referring to FIG. 7 in conjunction with FIG. 11, it is clear that the voltage regulator 100 includes three operational stages connected in a closed loop, where the pass transistor M_{P} serves as one operational stage, the voltage divider 101 serves as another operation stage, and the error amplifier 102 serves as yet another operational stage.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A current generating apparatus, for generating an output current, comprising:
a first current mirror, for generating a first mirror current according to a first bias current and a current mirror ratio;
a first bias current generator, coupled to the first current mirror, for providing the first bias current according to a first current and a reference current, the first bias current generator comprising:
a first current source, biased by a first bias voltage for providing the first current; and
a capacitive device, coupled to the first current source in parallel, for conducting the reference current;
a second current mirror, for generating a second mirror current according to a second bias current and the current mirror ratio;
a second bias current generator, coupled to the second current mirror, the second bias current generator having a second current source biased by the first bias voltage for generating a second current serving as the second bias current;
a third current source, coupled to an output node of the second current mirror, the third current source being biased by a second bias voltage for providing a third current, wherein the second mirror current is equal to the third current;
a feedback circuit, coupled to the output node of the second current mirror and the third current source, for tuning the second bias voltage according to a voltage level at the output node of the second current mirror and a target voltage level; and
a fourth current source, coupled to an output node of the first current mirror, the fourth current source being biased by the second bias voltage for providing a fourth current, wherein the output current is outputted at the output node of the first current mirror.

2. The current generating apparatus of claim 1, wherein the first current source comprises a first transistor having a control node coupled to the first bias voltage, a first node, and a second node coupled to a first reference voltage level; the second current source comprises a second transistor having a control node coupled to the first bias voltage, a first node, and a second node coupled to the first reference voltage level, and the first bias current generator further comprises:
a third transistor, having a first node coupled to the first current mirror, a second node coupled to the first node of the first transistor, and a control node; and
a first error amplifier, having a first input node coupled to a second reference voltage level, a second input node coupled to the second node of the third transistor, and an output node coupled to the control node of the third transistor; and
the second bias current generator further comprises:
a fourth transistor, having a first node coupled to the second current mirror, a second node coupled to the first node of the second transistor, and a control node; and
a second error amplifier, having a first input node coupled to the second reference voltage level, a second input node coupled to the second node of the fourth transistor, and an output node coupled to the control node of the fourth transistor.

3. The current generating apparatus of claim 1, wherein the third current source comprises a fifth transistor having a control node for receiving the second bias voltage, a first node coupled to the output node of the second current mirror, and a second node coupled to the first reference voltage level; the fourth current source comprises a sixth transistor having a control node coupled to the control node of the fifth transistor, a first node coupled to the output node of the first current mirror, and a second node coupled to the first reference voltage level, and the feedback circuit comprises:
a third error amplifier, having a first input node coupled to the first node of the fifth transistor, a second input node coupled to the target voltage level, and an output node coupled to the control node of the fifth transistor.

4. A feedback-controlled system, comprising:
a plurality of operational stages cascaded in a closed loop; and
a current generating apparatus, for generating an output current to an output of a first operational stage in the operational stages, the current generating apparatus comprising:
a first current mirror, for generating a first mirror current according to a first bias current and a current mirror ratio;
a first bias current generator, coupled to the first current mirror, for receiving an output of a second operational stage in the operational stages and providing the first bias current according to a first current and a reference current, the first bias current generator comprising:
a first current source, for providing the first current according to a first bias voltage and the output of the second operational stage; and
a capacitive device, coupled to the first current source in parallel, for conducting the reference current;
a second current mirror, for generating a second mirror current according to a second bias current and the current mirror ratio;
a second bias current generator, coupled to the second current mirror, the second bias current generator having a second current source for generating a second current serving as the second bias current according to the first bias voltage and the output of the second operational stage;
a third current source, coupled to an output node of the second current mirror, the third current source being biased by a second bias voltage for providing a third current, wherein the second mirror current is equal to the third mirror current;
a feedback circuit, coupled to the output node of the second current mirror and the third current source, for tuning the second bias voltage according to a voltage level at the output node of the second current mirror and a target voltage level; and
a fourth current source, coupled to an output node of the first current mirror, the fourth current source being biased by the second bias voltage for providing a fourth current, wherein the output current is outputted from the output node of the first current mirror.

5. The feedback-controlled system of claim 4, wherein the first current source comprises a first transistor having a control node coupled to the first bias voltage, a first node, and a second node coupled to a first reference voltage level; the second current source comprises a second transistor having a control node coupled to the first bias voltage, a first node, and a second node coupled to the first reference voltage level, and the first bias current generator further comprises:
a third transistor, having a first node coupled to the first current mirror, a second node coupled to the first node of the first transistor, and a control node; and
a first error amplifier, having a first input node coupled to a second reference voltage level, a second input node coupled to the second node of the third transistor, and an output node coupled to the control node of the third transistor; and
the second bias current generator further comprises:
a fourth transistor, having a first node coupled to the second current mirror, a second node coupled to the first node of the second transistor, and a control node; and
a second error amplifier, having a first input node coupled to the second reference voltage level, a second input node coupled to the second node of the fourth transistor, and an output node coupled to the control node of the fourth transistor.

6. The feedback-controlled system of claim 4, wherein the third current source comprises a fifth transistor having a control node for receiving the second bias voltage, a first node coupled to the output node of the second current mirror, and a second node coupled to the first reference voltage level; the fourth current source comprises a sixth transistor having a control node coupled to the control node of the fifth transistor, a first node coupled to the output node of the first current mirror, and a second node coupled to the first reference voltage level, and the feedback circuit comprises:
a third error amplifier, having a first input node coupled to the first node of the fifth transistor, a second node coupled to the target voltage level, and an output node coupled to the control node of the fifth transistor.

7. The feedback-controlled system of claim 4, wherein the current generating apparatus further comprises:
a loading sensing circuit, coupled to the first current mirror and the second current mirror, for sensing loading variation of the feedback-controlled system to adjust the current mirror ratio of the first current mirror and the second current mirror.

8. The feedback-controlled system of claim 7, wherein the loading sensing circuit decreases the current mirror ratio of the first current mirror and the second current mirror when detecting that the loading of the feedback-controlled system increases, and the loading sensing circuit increases the current mirror ratio of the first current mirror and the second current mirror when detecting that the loading of the feedback-controlled system decreases.

9. The feedback-controlled system of claim 4, being a voltage regulator, wherein the second operational stage comprises a pass transistor, the first operational stage is a voltage divider for providing a feedback voltage level according to an output voltage level passed by the pass transistor; and the operational stages also include a third operational stage comprising a fourth error amplifier having a first input node coupled to the voltage divider for receiving the feedback voltage level, a second input node coupled to the target voltage level, and an output node coupled to a control node of the pass transistor.

10. The feedback-controlled system of claim 9, wherein the first current source comprises a first transistor having a control node coupled to the first bias voltage, a first node, and a second node coupled to a first reference voltage level; the second current source comprises a second transistor having a control node coupled to the first bias voltage, a first node, and a second node coupled to the first reference voltage level, and the first bias current generator further comprises:
a third transistor, having a first node coupled to the first current mirror, a second node coupled to the first node of the first transistor, and a control node; and
a first error amplifier, having a first input node coupled to a second reference voltage level, a second input node coupled to the second node of the third transistor, and an output node coupled to the control node of the third transistor; and
the second bias current generator further comprises:
a fourth transistor, having a first node coupled to the second current mirror, a second node coupled to the first node of the second transistor, and a control node; and
a second error amplifier, having a first input node coupled to the second reference voltage level, a second input node coupled to the second node of the fourth transistor, and an output node coupled to the control node of the fourth transistor.

11. The feedback-controlled system of claim 9, wherein the third current source comprises a fifth transistor having a control node for receiving the second bias voltage, a first node coupled to the output node of the second current mirror, and a second node coupled to the first reference voltage level; the fourth current source comprises a sixth transistor having a control node coupled to the control node of the fifth transistor, a first node coupled to the output node of the first current mirror, and a second node coupled to the first reference voltage level, and the feedback circuit comprises:
a third error amplifier, having a first input node coupled to the first node of the fifth transistor, a second node coupled to the target voltage level, and an output node coupled to the control node of the fifth transistor.

12. The feedback-controlled system of claim 9, wherein the current generating apparatus further comprises:
a loading sensing circuit, coupled to the first current mirror and the second current mirror, for sensing loading variation of the voltage regulator to adjust the current mirror ratio of the first current mirror and the second current mirror.

13. The feedback-controlled system of claim 12, wherein the loading sensing circuit decreases the current mirror ratio of the first current mirror and the second current mirror when detecting that the loading of the voltage regulator increases, and the loading sensing circuit increases the current mirror ratio of the first current mirror and the second current mirror when detecting that the loading of the voltage regulator decreases.
